(19) United States
(12) Patent Application Publication
(10) Pub. No.: US 2026/0234970 A1
(43) Pub. Date: Aug. 13, 2026

(54) FLUSH TO FLEXIBLE DOOR HANDLE ASSEMBLY FOR A MOTOR VEHICLE

(71) Applicant: ADAC Plastics, Inc., Grand Rapids, MI (US)

(72) Inventors: Thomas William ALLEN, Gowen, MI (US); Arie Thayer LYLES, Rockford, MI (US); Kevin Scott WOLFF, Lowell, MI (US)

(21) Appl. No.: 19/532,588

(22) Filed: Feb. 6, 2026

Related U.S. Application Data
(60) Provisional application No. 63/757,506, filed on Feb. 12, 2025.

(51) Int. Cl. E05B 85/10; B60Q 3/267; E05B 85/12

(52) U.S. Cl. CPC E05B 85/107; B60Q 3/267; E05B 85/103; E05B 85/12

(57) ABSTRACT

A door handle assembly includes a housing mountable to a motor vehicle door with a top surface of the housing flush with the door, a flexible strip in a channel of the housing and having a thickness such that the strip, in a relaxed state, is flush with the door, at least one actuator guide disposed in the channel and secured to at least one end of the strip, and an actuator configured in a deactivated state to locate the at least one actuator guide within the channel so as to allow the strip to lie in the channel in the relaxed state, the actuator responsive to an activation signal to move the at least one actuator guide within the channel so as to cause the strip to bow outwardly away from the housing to define a grip pocket between the housing and the strip.

### CROSS-REFERENCE TO RELATED APPLICATION

This patent application claims the benefit of, and priority to, U.S. Provisional Patent Application Ser. No. 63/757,506, filed Feb. 12, 2025, the disclosure of which is incorporated herein by reference in its entirety.

### TECHNICAL FIELD

The present disclosure relates generally to door handle assemblies for motor vehicles, and more specifically to door handle assemblies which include an actuatable, flexible, or semi-flexible door handle

### BACKGROUND

Flush mounted door handles are known in motor vehicle applications, and are generally movable between stowed and deployed positions. Such door handles are typically provided in the form of rigid structures or assemblies that are electronically and/or manually movable between the rigid and stowed positions.

### SUMMARY

The present disclosure may comprise one or more of the features recited in the attached claims, and/or one or more of the following features and combinations thereof. In one aspect, a door handle assembly may comprise a housing having an opening, a bottom surface opposite the opening, and sides extending from the opening to the bottom surface so as to define a channel, having a depth, between the bottom surface and a top surface of the opening, the housing configured to be mounted to a door of a motor vehicle with the top surface of the housing at least approximately flush with or proud of a surface of the door, a flexible strip disposed in the channel, the flexible strip having a thickness corresponding to the depth of the channel such that, in a relaxed state of the flexible strip, a surface of the flexible strip exposed at the opening of the housing is at least approximately flush with the top surface of the opening, at least one actuator guide disposed in the channel and secured to at least one end of the flexible strip, and an actuator having a deactivated state and an activated state, the actuator configured in the deactivated state to locate the at least one actuator guide within the channel so as to allow the flexible strip to lie in the channel in the relaxed state, the actuator responsive to an activation signal to move the at least one actuator guide within the channel so as to cause the flexible strip to bow outwardly away from the housing to define a grip pocket between the housing and the flexible strip.

### BRIEF DESCRIPTION OF THE DRAWINGS

FIG. 1A is a simplified front plan view of an embodiment of a flush to flexible door handle assembly mounted to a door of a motor vehicle, shown with the flush to flexible door handle in a flush and deactivated position.

FIG. 1B is a simplified front plan view of the flush to flexible door handle assembly of FIG. 1A, shown with the flush to flexible door handle in an activated or deployed position to define a grip pocket between the exterior surface of the motor vehicle door and the flush to flexible door handle.

FIG. 2A is a simplified side and schematic view of the flush to flexible door handle assembly of FIGS. 1A and 1B, shown with an embodiment of an actuator positioning the flush to flexible door handle in the flush and deactivated position.

FIG. 2B is another side and simplified schematic view of the flush to flexible door handle assembly of FIGS. 1A and 1B, shown with the actuator of FIG. 2A positioning the flush to flexible door handle in the activated position.

FIG. 3A is a side and simplified schematic view of another embodiment of a flush to flexible door handle assembly, shown with another embodiment of an actuator positioning the flush to flexible door handle in the flush and deactivated position.

FIG. 3B is another side and simplified schematic view of the flush to flexible door handle assembly of FIG. 3A, shown with the actuator positioning the flush to flexible door handle in the activated position.

FIG. 4A is a simplified side and schematic view of yet another embodiment of a flush to flexible door handle assembly, shown with another embodiment of an actuator positioning the flush to flexible door handle in the flush and deactivated position.

FIG. 4B is another side and simplified schematic view of the flush to flexible door handle assembly of FIG. 4A, shown with the actuator positioning the flush to flexible door handle in the activated position.

FIG. 5A is a front perspective view of still another embodiment of a portion of a flush to flexible door handle assembly, shown with the flush to flexible door handle in the activated position.

FIG. 5B is a front perspective view of yet another embodiment of a portion of a flush to flexible door handle assembly equipped with illumination features, and shown with the flush to flexible door handle in the activated position.

FIG. 6A is a side elevational view of an embodiment of a core of the flush to flexible door handle illustrated by example in FIGS. 1A-5B.

FIG. 6B is a side perspective view of another embodiment of a core of the flush to flexible door handle illustrated by example in FIGS. 1A-5B.

FIG. 7A is a front perspective view of an embodiment of a flush to flexible door handle assembly integrated into an interior door panel of a motor vehicle door, shown with the flush to flexible door handle assembly in a flush and deactivated position.

FIG. 7B is a perspective view similar to FIG. 7A, showing the flush to flexible door handle assembly in an activated position to define a grip pocket, surface, or profile along the interior door panel.

FIG. 7C is a perspective view similar to FIG. 7B showing the flush to flexible door handle assembly of FIGS. 1A-2B overlaid onto the depiction of FIG. 7B to represent an example positioning and integration of the flush to flexible door handle assembly between the motor vehicle door and the fabric or skin of the interior door panel.

FIG. 8A is a perspective view similar to FIG. 7A, with the flush to flexible door handle assembly in the flush and deactivated position, illustrating an embodiment in which at least one illumination source or illumination panel is positioned between the motor vehicle door and the fabric or skin of the interior door panel.

FIG. 8B is a perspective view similar to FIG. 7B, with the flush to flexible door handle assembly in the activated position, showing illumination by the illumination source(s) or panel(s) through the perforations in the fabric or skin of the interior door panel.

### DESCRIPTION OF THE ILLUSTRATIVE EMBODIMENTS

For the purposes of promoting an understanding of the principles of this disclosure, reference will now be made to a number of illustrative embodiments shown in the attached drawings and specific language will be used to describe the same.

This disclosure relates to various embodiments of a flush to flexible door handle assembly for a motor vehicle. As used herein, the phrase “flush to flexible door handle assembly” refers to a door handle assembly including a door handle, i.e., the structure to be grasped or otherwise engaged by a hand of an operator or passenger in order to open a corresponding access closure of the motor vehicle, provided in the form of a flexible or semi-flexible material or composite which is to be controlled, e.g., by one or more actuators, between a first or “deactivated” position in which the door handle is “flush” with an outer surface of the door skin so as not to be able to be grasped by the operator or passenger, and a second or “activated” position in which a space is defined between the door handle and the motor vehicle door to allow the door handle to be grasped or otherwise engaged by the operator or passenger. As used herein, the term “flexible strip” is to be understood to mean a flexible or semi-flexible strip. The term “flush,” as used above, illustratively means that an outer surface of the door handle is at least approximately flush with an outer surface of the door skin of the motor vehicle door, or is at least approximately flush with an outer surface of a bracket or housing mounted to the motor vehicle door and to which the door handle is operatively mounted. It will be understood that “approximately flush” means that the outer surface of the door handle may be truly flush, i.e., such that the outer surface of the door handle and the outer surface of the door are co-planar, may be somewhat recessed within the motor vehicle door, bracket, or housing, i.e., such that the outer surface of the door handle is somewhat recessed within the door relative to the outer surface of the door or is somewhat recessed within the bracket or housing relative to an outer surface of the bracket or housing, or may be somewhat proud of the outer surface of the motor vehicle, bracket, or housing. In any case “flush” or “approximately flush” should be understood to mean that the door handle is positioned so as not to able to be adequately grasped or otherwise engaged by an occupant or passenger so as to allow the occupant or passenger to open the access closure in a conventional manner. The term “access closure,” as used herein, illustratively refers to a movable closure structure which may be manually and/or automatically movable, e.g., via one or more motors, actuators, or the like, between an open position through which access may be had via a respective access opening to one or more portions of the motor vehicle, and a closed position covering the access opening. Examples of access closures may include, but are not limited to, a hinged, e.g., swinging, side or rear door, a sliding door, tailgate, a lift gate, a trunk lid, a “frunk” lid, an engine compartment lid, or the like, and any one or more such examples may be entirely manually controlled, i.e., by the operator or passenger, between the open and closed positions, or may be powered, i.e., by one or more motors, actuators, or the like, so as to be completely automatically controlled between the open and closed positions, or so as to be “operator assisted,” i.e., controlled between open and closed and/or between closed and open positions by a combination of manual and automatic control.

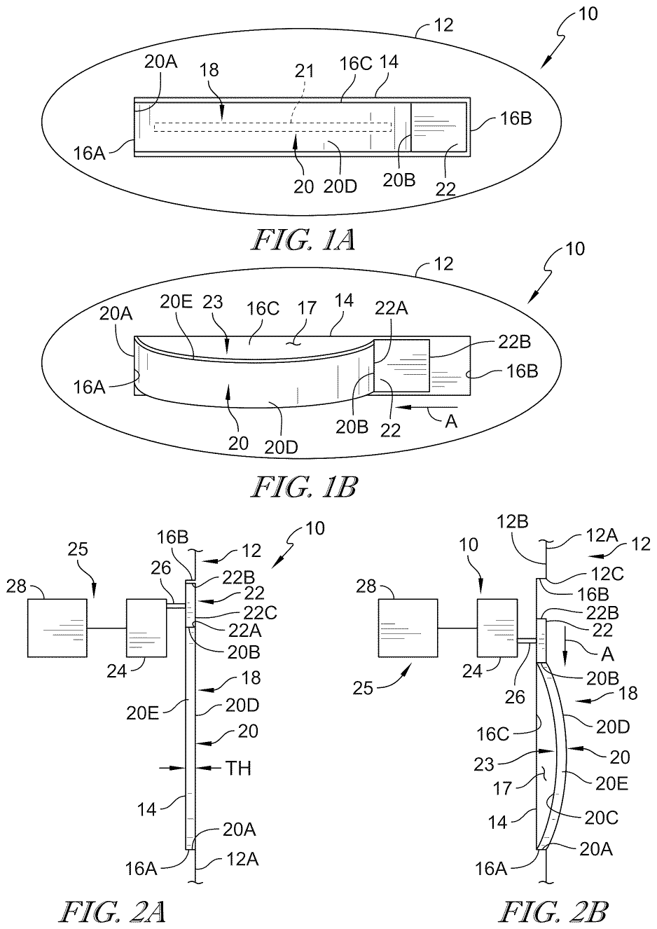

Referring now to FIGS. 1A-2B, an embodiment is shown of a flush to flexible door handle assembly 10 mounted to a door 12 of a motor vehicle. The door 12 illustratively has an outer or exterior surface 12A facing outwardly away from the door 12, an inner surface 12B facing opposite the outer surface 12A, and an opening 12C extending into the door 12. In the embodiment illustrated in FIGS. 1A-2B, item 12 illustratively represents a conventional door skin defining the opening 12C therethrough. In any case, a bracket or housing 14 extends into the opening 12C defined through the door 12, and the bracket or housing 14 is mounted to the door 12 in a conventional manner. The bracket or housing 14 defines sides 16A, 16B each extending downwardly to a bottom surface 16C, such that the bracket or housing 14 defines a recess or pocket 17 which extends into the door 12 between the outer surface 12A of the door 12 and the bottom surface 16C of the bracket or housing 14. In the illustrated embodiment, the bottom surface 16C is illustratively planar so as to define a linear surface extending between the two sides 16A, 16B, although in other embodiments the bottom surface 16C may be convex, concave, or otherwise shaped in a non-linear profile between the two sides 16A, 16B. In any case, the channel 17 is illustratively sized to receive a handle assembly 18 therein, wherein the handle assembly 18 includes a flush to flexible door handle 20 and an actuator guide 22 of an actuator assembly 30.

The door handle 20 is illustratively formed of a flexible or semi-flexible material or composite, and is illustratively provided in the form of a strip sized to be received within the channel 17 and having terminal ends 12A, 12B opposite one another, having an inner surface 20C facing the bottom surface 16C of the channel 17, and having an outer surface 20D opposite the inner surface 20C and facing outwardly away from the door 12 of the motor vehicle, all of which are formed by a body 20E of the door handle 20. As will be described in greater detail below, the flexible or semi-flexible door handle 20 is illustratively elastically deformable so that it may be bent or bowed between the two ends 12A, 12B and yet return to the planar shape illustrated by example in FIGS. 1A and 2A. In some embodiments, the body 20E of the door handle 20 is biased so as to return to the planar shape after being bent or bowed. In any case, the actuator guide 22 is also illustratively sized to be received within the channel 17, and has terminal ends 22A, 22B opposite one another. Illustratively, the end 20A of the door handle 20 is attached or otherwise secured to the side 16A of the bracket or housing 14, and the opposite end 20B of the door handle 20 is attached or otherwise secured to the end 22A of the actuator guide 22 such that the actuator guide 22 is positioned within the channel 17 between the end 20A of the door handle 20 and the side 16A of the bracket or housing 14. In alternate embodiments, the end 20B of the door handle 20 may be attached or otherwise secured to the side 16B of the bracket or housing 14, and the opposite end 20B of the door handle 20 may be attached or otherwise secured to the end 22B of the actuator guide 22 such that the actuator guide 22 is positioned within the channel 17 between the end 20B of the door handle 20 and the side 16B of the bracket or housing 14

In addition to the actuator guide 22 disposed within the channel 17 of the bracket or housing 14 and secured to the end 20B of the door handle 20, the actuator assembly 25 further illustratively includes a conventional, electro-mechanical actuator 24 operatively coupled to the actuator guide 22, and a conventional controller or processor circuit 28 electrically connected to the actuator 24. In the illustrated embodiment (see, e.g., FIGS. 2A and 2B), the actuator 24 is operatively coupled to the actuator guide 22 by an actuator arm 26, e.g., in the form of a tab, post, or pin, extending from the actuator 24 and attached or otherwise secured to the actuator guide 22. In such embodiments, the bottom surface 16C of the bracket or housing 14 illustratively defines a slot therethrough via which the actuator arm 26 can extend into the channel 17 and into connection with the actuator guide 22, and along which the actuator arm 26 can move in the axial direction along the elongated channel 17. In alternate embodiments, the actuator 24 may be operatively coupled to the actuator guide 22 via one or more other conventional structures, although in any case the actuator 24 is illustratively a linear actuator responsive to control signals produced by the controller or processor circuit 28 to move the actuator arm 26 in the axial direction along the channel 17 so as to move the handle assembly 18 between the activated and deactivated positions as will be described in further detail below. It will be understood that in alternate embodiments, the actuator 24 may be a conventional rotary actuator and the actuator assembly 25 may, in such embodiments, include one or more conventional structures to convert the rotary motion of the actuator 24 to linear motion of the actuator guide 22 along the channel 17 defined by the bracket or housing 16. In the illustrated embodiment, the actuator guide 22 is illustratively implemented in the form of a plate-type structure sized to be received within, and movable along, the channel 17 defined by the bracket or housing 16, although this structure should not be considered limiting in any way as the actuator guide 22 may alternatively be provided in the form of any conventional structure configured to apply the actuating force of the actuator 24 to the door handle 20 of the handle assembly 18.

In the examples shown in FIGS. 1A and 2A, the handle assembly 18 is in the “deactivated” position, and in the examples shown in FIGS. 1B and 2B the handle assembly 18 is in the “activated” position. In the deactivated position, the end 22B of the actuator guide 22 is at or near the side 16B of the bracket or housing 14, and in some embodiments the end 22B of the actuator guide 22 may be in contact with the side 16B of the bracket or housing 14. As best seen in FIG. 2A, the door handle 20 is illustratively sized to have a thickness TH approximately equal to the depth of the channel 17 defined by the bracket or housing 14 between the outer surface 12A of the door 12 and the bottom surface 16C of the channel 17 (i.e., defined by the lengths of the sides 16A, 16B of the bracket or channel 14). With the handle assembly 18 in the deactivated position, the outer surface 20D of the door handle 20 positioned in the channel 17 is thus flush, or at least approximately flush as described above, with the outer surface 12A of the door 12 as illustrated by example in FIGS. 1A and 2A. In some embodiments, the bracket or housing 14 may include a rim that surrounds, or at least partially surrounds, the channel 17, and in such embodiments the rim of the bracket or housing 14 may be proud, i.e., extend outwardly away from, the outer surface 12A of the motor vehicle door 12. In such embodiments, the depth of the channel 17 will extend between the outer surface of the rim and the bottom surface 16D of the channel 17, and the thickness TH of the door handle 20 will accordingly be sized such that, with the door handle 20 positioned in the deactivated position within the channel 17, the outer surface of the door handle 20 will be flush, or at least approximately flush, with the outer surface of the rim which surrounds, or at least partially surrounds, the channel 17. In the embodiment illustrated be example in FIGS. 1A-2B, the actuator guide 22 has the same thickness as that of the door handle 20 such that the outer surface 20D of the door handle 20 is flush, or at least approximately flush, with the outer surface 22C of the actuator guide 22 (see, e.g., FIG. 2A). It will be understood, however, that this is not a requirement, and that in other embodiments the outer surface 22C of the actuator guide 22 may be recessed relative to the outer surface 20D of the door handle 20 or may be proud of the outer surface 20D of the door handle 20.

The controller or processor circuit 28 illustratively includes a memory having instructions stored therein which are executable by the controller or processor circuit to be responsive to activation and deactivation commands to control operation of the actuator 24, i.e., to control the position of the handle assembly 18 between the activated and deactivated positions. In alternate embodiments, the controller or processor 28 may be or include one or more application specific integrated circuits (ASICs) designed to be responsive to activation and deactivation commands to control operation of the actuator 24. Such activation and deactivation commands may illustratively be provided by one or more sensors, switches, or the like mounted to the motor vehicle and hardwired to the controller or processor circuit 28, and responsive to touch actuation, or defined sequence of touch actuation, to produce the respective activation and deactivation commands. Alternatively or additionally, the controller or processor circuit 28 may be equipped with, or operatively connected to, wireless communication circuitry configured to wirelessly receive and act upon activation and deactivation commands produced by one or more mobile wireless communication devices, e.g., key fob, smart phone, etc. Alternatively or additionally still, the controller or processor circuit 28 may be equipped with, or operatively connected, to one or more sensors mounted to the motor vehicle and configured to sense movement, e.g., speed, direction, etc., and/or gesture(s), e.g., hand, arm, foot, leg, etc.) of an motor vehicle operator, and to produce the activation and/or deactivation signals based on such sensed movement and/or gesture(s). Such one or more sensors may illustratively be or include, but are not limited to, any one or combination of at least one infrared sensor, at least one radar transmitter/receiver combination (or transceiver), at least one ultra-wideband transmitter/receiver combination (or transceiver), or the like.

In any case, operation of the actuator 24 to move the handle assembly 18 from the deactivated position, illustrated by example in FIGS. 1A and 2A, to the activation position, is illustrated by example in FIGS. 1B and 2B. In response to an activation command, as just described, the controller or processor circuit 28 is operable to produce a corresponding activation signal and provide the activation signal to a respective signal input of the electro-mechanical actuator 24 which is, in turn, responsive to the activation signal to move the actuator guide 22 from the deactivated position at or adjacent to the side 16B of the bracket or housing 14 toward the opposite side 16A along the direction A illustrated in FIGS. 1B and 2B (i.e., along the axial direction of the elongated channel 17). Due to the flexible or semi-flexible nature of the door handle 20, and because the end 20A of the door handle 20 is secured to the opposite side 16A of the bracket or housing 14, such movement of the actuator guide 22 along the channel 17 in the direction A causes the door handle 20 to elastically deform and bow outwardly so as to produce an opening 23 between the inner surface 20C of the door handle 20 and the bottom surface 16C of the bracket or housing 14. As the actuator 24 continues to move the actuator guide 22 along the channel 17 in the direction A, the flexible or semi-flexible door handle 20 continues to bow outwardly so as to increase the area of the opening 23. At the end of the movement of the actuator 24 in response to the activation signal, illustrated by example in FIGS. 1B and 2B, the opening 23 defined by the bowed door handle 20 illustratively extends sufficiently beyond the outer surface 12A of the door 12 (or beyond the outer surface of the rim extending at least partially around the channel 17 of the bracket or housing 14 in embodiments which include such a rim) so as to form a “grip pocket” which allows at least a portion of a hand, e.g., at least one finger and desirably all of the fingers, of the motor vehicle operator and/or passenger to extend into the opening 23 so as to grasp the door handle 20 to allow for opening the motor vehicle door in a conventional manner.

In response to a deactivation command, the controller or processor 28 is operable to produce a corresponding deactivation command and to provide the deactivation signal to a respective signal input of the electro-mechanical actuator 24. The actuator 24 is, in turn, responsive to the deactivation signal to move the actuator guide 22 back to the deactivated position of the actuator guide 22 at, adjacent to, or in contact with the side 16B of the bracket or housing 14. The door handle 20 is illustratively biased such that as the actuator guide 22 moves back to the deactivated position, the door handle 20 transitions back to its elongated, linear shape until the outer surface 20D is once again flush, or at least approximately flush, with the outer surface 12A of the door 12 (or with the outer surface of the rim which at least partially surrounds the channel 17 of the bracket or housing 14 in embodiments which include such a rim).

In some embodiments, the door handle assembly 10 may be fitted with one or more illumination devices 21, e.g., as illustrated by example in FIG. 1A, so as to provide a visual guide thereto and/or to distinguish between the activated and deactivated states just described. Although FIG. 1A illustrates such one or more illumination devices 21 as being attached to or integral with the body 20E of the door handle 20, it will be understood that any such one or more illumination devices 21 may alternatively or additionally be mounted to, behind, or integral with the body 20E of the door handle 20, the actuator guide 22, any portion of the exterior surface 12A (e.g., the door skin) extending along the bracket or housing 14, and/or any portion of a rim of the bracket or housing 14 that may extend at least partially about the channel 17 as described above. In any such embodiment, the controller or processing circuit 28 may be configured to control any such one or more illumination devices to illuminate upon activation, or to illuminate during deactivated and activated conditions with some type of change in illumination, e.g., color, intensity, pulse rate, etc., between the two conditions.

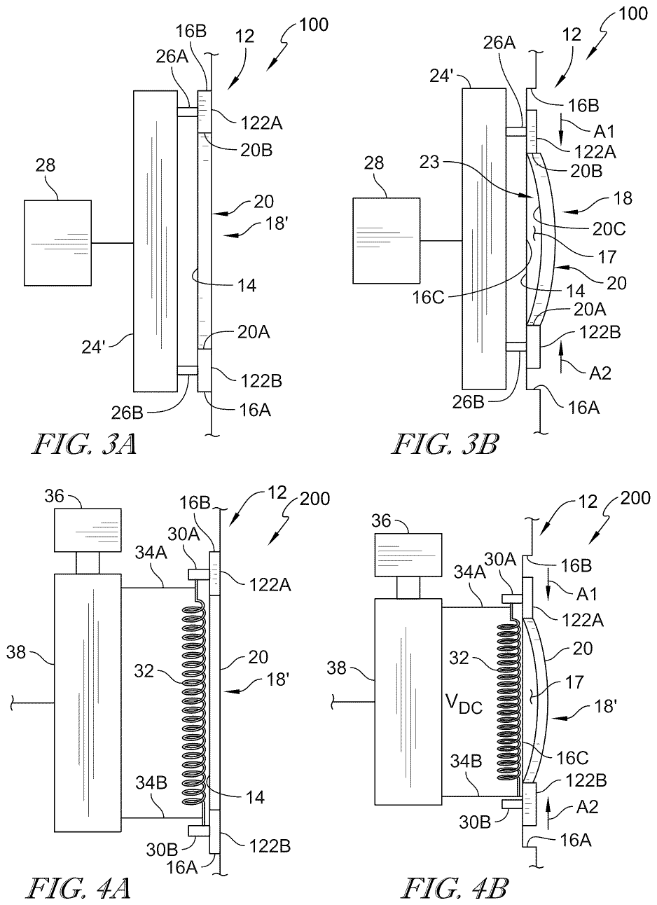

Referring now to FIGS. 3A and 3B, an alternate embodiment is shown of a flush to flexible door handle assembly 100. The door handle assembly 100 is identical in many respects to the door handle assembly 10 illustrated in FIGS. 1A-2B and described above, and like reference numbers are therefore used in FIGS. 3A and 3B to identify those elements in common with the door assembly illustrated by example in FIGS. 1A-2B. Illustratively, the door handle assembly 100 differs from the door handle assembly 10 primarily in the handle assembly 18′ which includes two separate actuator guides 122A, 122B each controlled by a single actuator 24′ or, in some embodiments, by separate actuators. In the illustrated embodiment, the actuator guide 122A is illustratively identical, or at least similar, to the actuator guide 22A illustrated and described above with respect to FIGS. 1A-2B, and is attached or otherwise secured to the end 20B of the door handle 20 as also described above. Another actuator guide 122B, identical or similar to the actuator guide 122A, is disposed in the channel 17 between the side 16A of the bracket or housing 14 and the opposite end 20A of the door handle 20, wherein the actuator guide 122B is attached or otherwise secured to the end 20A of the door handle 20 as described above with respect to the actuator guide 22. The actuator guide 122A is operatively coupled to the actuator 24′ via an actuator arm 126A that is identical or similar to the actuator arm 26 described above. A second actuator arm 126B is operatively coupled between the actuator 24′ and the actuator guide 122B. It will be understood that any one or combination of the alternative or additional features and/or variants described above with respect to the door handle assembly 10 may likewise be applicable to the door handle assembly 100.

Operation of the actuator 24′ to move the handle assembly 18′ from the deactivated position, illustrated by example in FIG. 3A, to the activation position, is illustrated by example in FIG. 3B. In response to an activation command, described above, the controller or processor circuit 28 is operable to produce a corresponding activation signal and provide the activation signal to a respective signal input of the electro-mechanical actuator 24′ which is, in turn, responsive to the activation signal to move the actuator guide 122A from the deactivated position at or adjacent to the side 16B of the bracket or housing 14 toward the opposite side 16A along the direction A1, and to simultaneously move the actuator guide 122B from the deactivated position at or adjacent to the side 16A of the bracket or housing 14 toward the opposite side 16B along the direction A2, opposite A1, as illustrated in FIG. 3B (i.e., both directions A1 and A2 opposite one another along the axial direction of the elongated channel 17). Due to the flexible or semi-flexible nature of the door handle 20, such movement of the actuator guides 122A and 122B in toward one another along the channel 17 in the directions A1 and A2 respectively causes the door handle 20 to elastically deform and bow outwardly so as to produce the opening 23 between the inner surface 20C of the door handle 20 and the bottom surface 16C of the bracket or housing 14 as described above with respect to FIGS. 1A-2B. As the actuator 24′ continues to move the actuator guides 122A and 122B toward one another along the channel 17 in the directions A1 and A2 respectively, the flexible or semi-flexible door handle 20 continues to bow outwardly so as to increase the area of the opening 23. At the end of the movement of the actuator 24′ in response to the activation signal, illustrated by example in FIG. 3B, the opening 23 defined by the bowed door handle 20 illustratively extends sufficiently beyond the outer surface 12A of the door 12 (or beyond the outer surface of the rim extending at least partially around the channel 17 of the bracket or housing 14 in embodiments which include such a rim) so as to allow at least a portion of a hand, e.g., at least one finger and desirably all of the fingers, of the motor vehicle operator and/or passenger to extend into the opening 23 so as to grasp the door handle 20 to allow for opening the motor vehicle door in a conventional manner

In response to a deactivation command, the controller or processor 28 is operable to produce a corresponding deactivation command and to provide the deactivation signal to a respective signal input of the electro-mechanical actuator 24′. The actuator 24′ is, in turn, responsive to the deactivation signal to move the actuator guides 122A and 122B back to their respective deactivated positions at, adjacent to, or in contact with the respective sides 16B, 16A of the bracket or housing 14. The door handle 20 is illustratively biased such that as the actuator guides 122A, 122B move back to their deactivated positions, the door handle 20 transitions back to its elongated, linear shape until the outer surface 20D is once again flush, or at least approximately flush, with the outer surface 12A of the door 12 (or with the outer surface of the rim which at least partially surrounds the channel 17 of the bracket or housing 14 in embodiments which include such a rim).

Referring now to FIGS. 4A and 4B, another alternate embodiment is shown of a flush to flexible door handle assembly 200. The door handle assembly 200 is identical in many respects to the door handle assembly 110 illustrated in FIGS. 3A and 3B and described above, and like reference numbers are therefore used in FIGS. 4A and 4B to identify those elements in common with the door assembly illustrated by example in FIGS. 3A and 3B. Illustratively, the door handle assembly 200 differs from the door handle assembly 100 primarily in the type of actuator used to control activation and deactivation of the handle assembly 18′. In place of the linear actuator 24′ illustrated in FIGS. 3A and 3B, for example, a shape memory alloy wire or wires 32 is/are attached, electrically and mechanically, to and between actuator arms 30A and 30B respectively secured to the actuator guides 122A, 122B. The end of the shape memory alloy wire(s) 32 attached to the actuator arm 30A is electrically connected via an electrical wire or other connector 34A to one output of a driver circuit 38, and the opposite end of the shape memory alloy wire(s) 32 attached to the actuator arm 30B is electrically connected via another electrical wire or other connector 34B to another output of the driver circuit 38, and the driver circuit 38 is operatively connected to a voltage source 36, e.g., a conventional DC voltage source. In some embodiments, the actuator arms 30A and 30B are electrically conductive, and the shape memory alloy wire(s) 32 as well as the wires or other connectors 34A, 34B are electrically and mechanically attached to such actuator arms 30A, 30B.

The driver circuit 38 is illustratively conventional, and is controlled by the controller or processor circuit 28 (connecting wire to the driver circuit 38 shown in FIGS. 4A and 4B). The shape memory alloy wire(s) 32 is/are illustratively conventional and normally has a length which positions the actuator guides 122A, 122B in their respective deactivated positions (described above). In response to the activation signal produced by the controller or processor circuit 28 as described above, the driver circuit 38 applies voltage from the voltage supply 36 across the shape memory alloy wire(s) 32 with sufficient magnitude to cause the shape memory alloy to rapidly heat to above a thermal transition point. At and above the thermal transition point, the shape memory alloy wire(s) 32 shrink in length which, in turn, moves the actuator guides 122A, 122B toward one another as described above. The minimum length to which the shape memory alloy wire(s) 32 shrink in response to the applied voltage is illustratively selected so as to cause the activated positions of the actuator guides 122A, 122B to the same positions illustrated in FIG. 3B and described above. In some embodiments, conventional mechanical amplifiers may be used to amplify movement of either or both of the actuator arms 30A, 30B in response to shrinkage of the shape memory alloy wire(s) 32. In response to the deactivation signal produced by the controller or processor circuit 28, the driver circuit 32 removes the voltage from the shape memory alloy wire(s) 32 which results in cooling of the wire(s) 32 to below the thermal transition point whereby the shape memory alloy wire(s) 32 expand and return to its/their original length to position the actuator guides 122A, 122B in their respective deactivated positions illustrated by example in FIG. 4A. The shape memory alloy wire(s) 32 is/are illustratively conventional, and may be provided in any known form, an example of which may be, but is not limited to, a conventional nickel-titanium alloy known as “nitinol.” It will be understood that any one or combination of the alternative or additional features and/or variants described above with respect to the door handle assembly 10 may likewise be applicable to the door handle assembly 200.

Although the actuator guide 22 is shown in FIGS. 1A-2B, and the actuator guides 122A, 122B are shown in FIGS. 2A-4B, as being located within a portion of the channel 17 that will be visible from outside of the motor vehicle, it will be understood that this arrangement represents only one example embodiment and that other embodiments are contemplated in which the bracket or housing 14 is configured such that a portion of the channel 17 adjacent to the side 16B (and/or a portion of the channel adjacent to the side 16A) extends under the exterior surface 12A of the door 12, e.g., under the door skin, and in which such portion is sized such that the actuator guide 22 or the actuator guides 122A, 122B remain(s) covered by the exterior surface 12A of the door, e.g., covered by the door skin, throughout movement of the actuator guide 22 between the deactivated and activated positions of the handle assembly 18, i.e., such that only the flexible or semi-flexible door handle remains visible outside of the motor vehicle. It will be further understood that whereas the body 20E of the flexible or semi-flexible door handle 20 is illustrated in FIGS. 1A-4B as being flexible or semi-flexible entirely along its length, alternate embodiments are contemplated in which a portion of the body 20E of the door handle 20 adjacent to the end 20A and/or adjacent to the end 20B is/are rigid and the remainder of the body 20E is flexible or semi-flexible such that only the flexible or semi-flexible portion of the body 20E deforms so as to form the opening 23 illustrated in FIGS. 1B, 2B, 3B, and 4B as described above

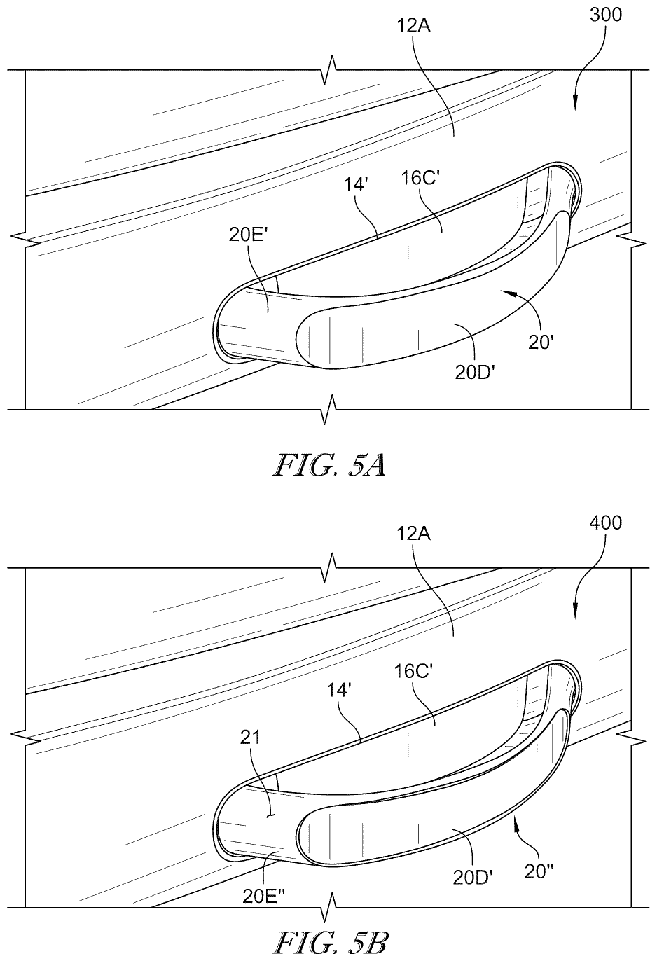

Referring now to FIG. 5A, yet another alternate embodiment is shown of a flush to flexible door handle assembly 300 which illustratively includes some of the features and/or variants of the door handle assemblies 10, 100, 200 described above. As one example, the bracket or housing 14′ is modified such that the bottom surface 16C′ of the bracket or housing 14′ is convex as briefly described above, which may illustratively reduce the amount of deformation or bowing required of the door handle 20′ when transitioning between the deactivated and activated states thereof. As another example, the axial length of the bottom surface 16′ of the bracket or housing 14′ is increased relative to that illustrated by example in FIGS. 1A-4B, such that the actuator guide(s), in either (or between) the activated and deactivated positions thereof, is/are not visible externally to the motor vehicle door. As a further example, the general cross-sectional shape of the body 20E′ of the door handle 20′ is circular or oval, whereas a central portion 20D′ of the door handle 20′ is illustratively flattened which may illustratively facilitate flush positioning of the external surface 20D′ with the external surface 12A of the motor vehicle door in the deactivated position of the door handle 20′.

Referring now to FIG. 5B, still another alternate embodiment is shown of a flush to flexible door handle assembly 400 which illustratively includes another feature and/or variant of the door handle assemblies 10, 100, 200 described above. The assembly 400 is identical in many respects to the assembly 300 illustrated in FIG. 5A, and differs from the assembly 300 primarily in that the body 20E″ of the door handle 20″ includes, or is optically coupled to, one or more illumination sources 21. In the activated position of the door handle 20″ illustrated by example in FIG. 5B, the body 20E″ is illuminated as compared with the body 20E′ of the assembly 300 illustrated in FIG. 5A. The assembly 400 is otherwise identical to the assembly 300. In some alternate embodiments, however, the illumination source(s) 21 and/or the body 20E″ of the door handle 20″ may be configured such that only the flattened portion 20D′ is illuminated by the illumination source(s) 21, or such that the body 20E″ and the flattened portion 20D′ are illuminated together by the illumination source(s) 21.

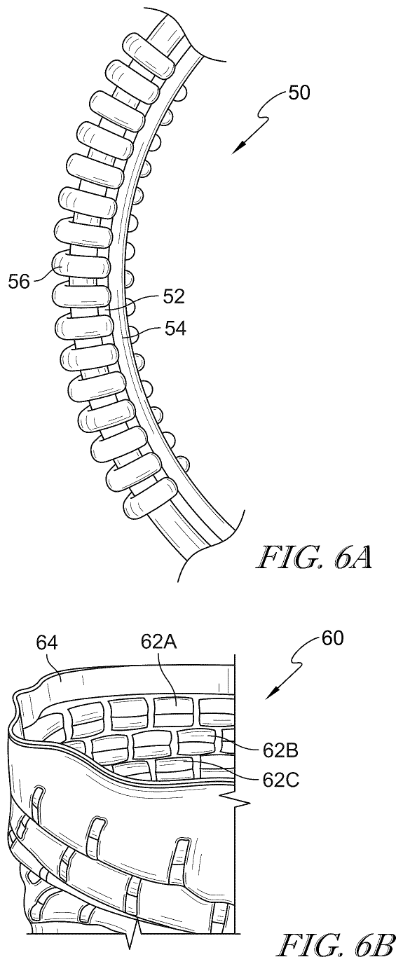

Referring now to FIG. 6A, an example embodiment of a core 50 of the door handle 20, 20′, 20″ is shown. In the illustrated embodiment, the door handle core 50 includes an elongated core member 52 coupled along its length to an elongated biasing member 54, with a conventional coiled spring 56, e.g., steel, or other conventional material(s), wrapped about the core member 52. The coiled spring 56 and the elongated biasing member 54, e.g., a steel spring, illustratively assist in the deformation or bowing of the door handle 20, 20′, 20″ as the door handle 20, 20′, 20″ is moved from the deactivated to the activated position, while also allowing for relaxation of the door handle 20, 20′, 20″ as the door handle 20, 20′, 20″ is moved from the activated to the deactivated position. FIG. 6B illustrates another example embodiment of a core 60 of the door handle 20, 20′, 20″. The core 60 illustrated in FIG. 6B includes a number of pairs of elongated biasing members, e.g., springs, extending side-by-side through, and coupled to, a flexible carrier sleeve 64. In the illustrated embodiment, three such pairs 62A, 62B, 62C of elongated biasing members are shown, although it will be understood that more or fewer such pairs may alternatively be used. In either of the embodiments of the core 50, 60 illustrated by example in FIGS. 6A and 6B, the respective core may illustratively be over molded, e.g., with any suitable polymer or other conventional over molding material(s), such that the over molded layer surrounds the core 50, 60, such that the core 50, 60 extends at least once through the over molded layer, or such that the core 50, 60 lies adjacent to (along the top or bottom of) the over molded layer, to form the finished door handle 20, 20′, 20″.

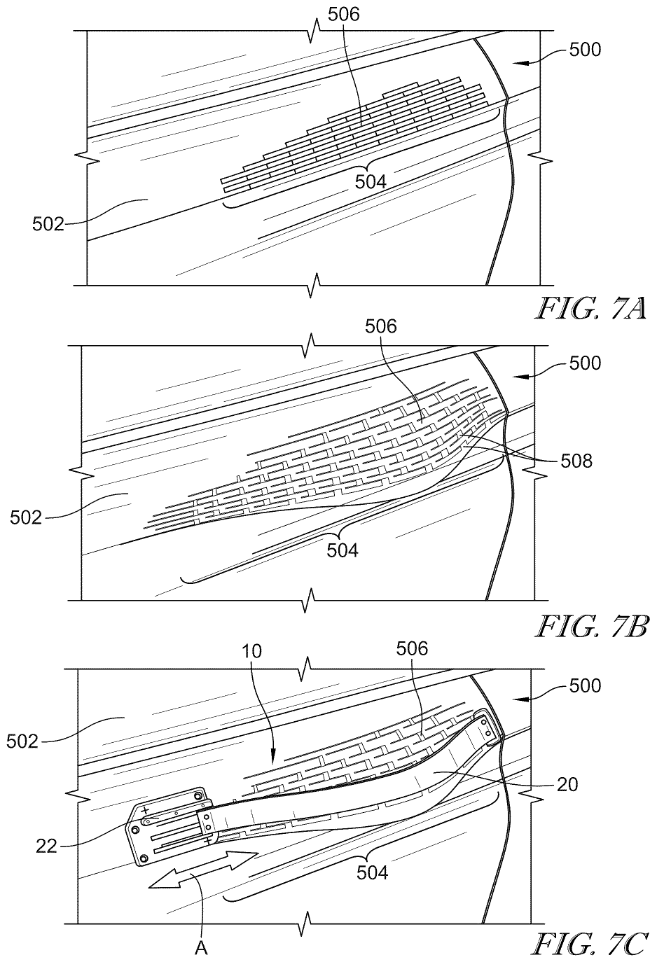

In the examples depicted in FIGS. 1A-5B, the door handle assemblies 100, 200, 300, and 400 are illustratively exterior door handles; that is, they are each shown mounted to a motor vehicle door so as to extend outwardly away from, and to be accessible from, the exterior surface 12A of the motor vehicle door. It will be understood that any such door handle assemblies 100, 200, 300, 400 may also be adapted for use as interior door handles; that is, configured to extend outwardly away from, and to be accessible from, the interior surface of the motor vehicle door; i.e., from within the motor vehicle. An example of one such embodiment of an interior door handle assembly 500 is illustrated by example in FIGS. 7A-7C. As depicted by example in FIG. 7A, a portion 504 of an interior surface 502 of a motor vehicle door may be fitted with a stretchable or expandable covering 506. In the illustrated embodiment, the covering 506 is perforated so as to expose openings 508 of increasing area as the covering 506 expands outwardly away from the motor vehicle door, as depicted by example in FIG. 7B. As further illustrated by overlay in FIG. 7C, the door handle assembly 10 (for example) is shown mounted under the portion 504 of the cover 506 so as to face away from the interior surface 502 of the motor vehicle door. The actuator guide 22 of the assembly 100 is mounted at or near one end of the area 504, one end of the door handle 20 is attached to the actuator guide 22, and the other end of the door handle 20 is attached to the motor vehicle door at or near the opposite end of the area 504. In the deactivated state of the assembly 10, the door handle 20 will be flush, or at least approximately flush, with an interior surface of the motor vehicle door that is beneath the stretchable or expandable covering 506, and in this state of the assembly 10 the covering 506 will thus be relaxed and formed against the interior surface of the motor vehicle door as illustrated by example in FIG. 7A. As the assembly 10 is activated from the deactivated state, movement of the actuator guide 22 toward the end of the door handle 20 that is attached to the motor vehicle door will cause the door handle 20 to deform and bow outwardly away from the interior surface of the motor vehicle door as described above, thus acting against the interior surface of the covering 506 and causing the covering to stretch or expand outwardly toward the interior area of the motor vehicle as depicted by example in FIG. 7B. The stretchable or expandable covering 506 may be any conventional material suitable for use on and/or along at least a portion of the interior surface of the door 12 which covers the door handle assembly 10. In the fully activated state of the door handle assembly 10, the fully bowed door handle 20 acting against the covering 506 shapes the portion 504 of the covering 506 in the form of a grip pocket, surface, or profile configured to be grasped, grabbed or otherwise engaged by the hand, or at least by a thumb and one or more fingers, of the motor vehicle occupant to thereby provide for controlled movement of the motor vehicle door outwardly to an open position and/or inwardly to a closed position. Deactivation of the door handle assembly 10, as described above, will cause the door handle 20 to move back to the flush, or approximately flush, position, thereby allowing the covering to relax back to the deactivated position illustrated in FIG. 7A. It will be understood that whereas the door handle assembly 10 is illustrated in FIG. 7C, this is only for the purpose of illustrating operation of the embodiment 500, and that the door handle assembly 100, 200, 300, or 400 may alternatively be used in place of the door handle assembly 10 in the embodiment 500 of FIGS. 7A-7C.

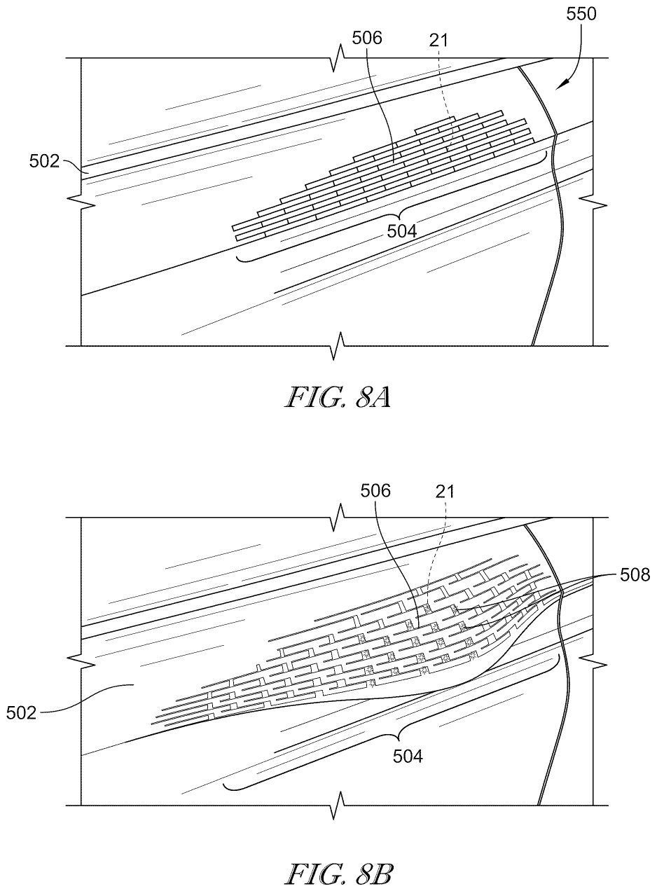

FIGS. 8A and 8B illustrate a variant 550 of the interior door handle assembly 500 is illustrated in FIGS. 7A-7C. In the embodiment depicted in FIGS. 8A and 8B, the door handle assembly 550 is illustratively identical, or at least similar, to the door handle assembly 500 shown by example in FIGS. 7A-7C, except that the door handle assembly 550 includes one or more illumination devices 21 mounted to the motor vehicle door beneath the covering 506. In embodiments in which the covering 506 in the area 504 of the interior surface 502 of the motor vehicle door is perforated as described above, such perforations 508 open with increasing area as the covering 506 expands in the area 504 resulting from deployment of the door handle assembly 10 to the activated position. As a result, radiation from the one or more illumination sources 21 is seen through the opening perforations 508, thereby providing at least the same illumination benefits described above. It will be understood that the one or more illumination sources 21, in the embodiment illustrated by example in FIGS. 8A and 8B, may be mounted to or made integral with any component of the motor vehicle door, any component of the door handle assembly 10, 100, 200, 300, or 400, or any combination thereof.

While this disclosure has been illustrated and described in detail in the foregoing drawings and description, the same is to be considered as illustrative and not restrictive in character, it being understood that only illustrative embodiments thereof have been shown and described and that all changes and modifications that come within the spirit of this disclosure are desired to be protected.

What is claimed is:

1. A door handle assembly, comprising:
a housing having an opening, a bottom surface opposite the opening, and sides extending from the opening to the bottom surface so as to define a channel, having a depth, between the bottom surface and a top surface of the opening, the housing configured to be mounted to a door of a motor vehicle with the top surface of the housing at least approximately flush with or proud of a surface of the door,
a flexible strip disposed in the channel, the flexible strip having a thickness corresponding to the depth of the channel such that, in a relaxed state of the flexible strip, a surface of the flexible strip exposed at the opening of the housing is at least approximately flush with the top surface of the opening,
at least one actuator guide disposed in the channel and secured to at least one end of the flexible strip, and
an actuator having a deactivated state and an activated state, the actuator configured in the deactivated state to locate the at least one actuator guide within the channel so as to allow the flexible strip to lie in the channel in the relaxed state, the actuator responsive to an activation signal to move the at least one actuator guide within the channel so as to cause the flexible strip to bow outwardly away from the housing to define a grip pocket between the housing and the flexible strip.

2. The door handle assembly of claim 1, wherein the at least one actuator guide comprises a single actuator guide secured to one end of the flexible strip,
and wherein the opposite end of the flexible strip is secured to one of the sides of the housing such that movement of single actuator guide with the channel in response to the activation signal is in a direction toward the opposite end of the flexible strip.

3. The door handle assembly of claim 2, wherein the actuator is responsive to a deactivation signal to move the single actuator guide within the channel in a direction away from the opposite end of the flexible strip so as to allow the flexible strip to lie in the channel in the relaxed state.

4. The door handle assembly of claim 1, wherein the at least one actuator guide comprises:
a first actuator guide secured to one end of the flexible strip, and
a second actuator guide secured to an opposite end of the flexible strip,
wherein the actuator is configured in the deactivated state to locate the first and second actuator guides within the channel so as to allow the flexible strip to lie in the channel in the relaxed state.

5. The door handle assembly of claim 4, wherein the actuator is responsive to the activation signal to move the first and second actuator guides within the channel toward one another so as to cause the flexible or semi-flexible strip to bow outwardly away from the housing to define the grip pocket between the housing and the flexible strip.

6. The door handle assembly of claim 5, wherein the actuator is responsive to a deactivation signal to move first and second actuator guides within the channel in a direction away from one another so as to allow the flexible strip to lie in the channel in the relaxed state.

7. The door handle assembly of claim 1, wherein the at least one actuator guide comprises:
a first actuator guide secured to one end of the flexible strip, and
a second actuator guide secured to an opposite end of the flexible strip,
wherein the actuator comprises:
at least one shape memory alloy wire attached to and between the first and second actuator guides, and
means responsive to the activation signal to heat the at least one shape memory alloy wire to a temperature beyond a thermal transition temperature to cause the at least one shape memory alloy wire to shrink in length and thereby move the first and second actuator guides within the channel toward one another so as to cause the flexible or semi-flexible strip to bow outwardly away from the housing to define the grip pocket between the housing and the flexible strip.

8. The door handle assembly of any of claims 1 through 7, wherein the top surface of the housing is approximately flush with the surface of the door.

9. The door handle assembly of any of claims 1 through 7, wherein housing includes a rim extending at least partially about the opening, the rim having a top surface and a bottom surface opposite the top surface, the housing configured to be mounted to the door of the motor vehicle with the bottom surface of the rim in contact with the surface of the door and with the top surface of the rim proud of the surface of the door,
and wherein a top surface of the rim defines the top surface of the housing.

10. The door handle assembly of any of claims 1 through 9, further comprising at least one illumination device configured to illuminate in response to the activation signal.

11. The door handle assembly of claim 10, wherein the at least one illumination device is attached to, integral with, or optically coupled to, the flexible strip.

12. The door handle assembly of claim 10, wherein the at least one illumination device is attached to, integral with, or optically coupled to the housing.

13. The door handle assembly of any of claims 1 through 12, wherein the bottom surface of the housing is planar, such that the flexible strip, in the relaxed state, lies in the channel along a plane.

14. The door handle assembly of any of claims 1 through 12, wherein the bottom surface of the housing is convex, such that the flexible strip, in the relaxed state, lies in the channel along an arc defined by the convex bottom surface of the housing.

15. The door handle assembly of any of claims 1 through 14, wherein the flexible strip comprises a core and an over molded layer, with over molded layer surrounding the core, with the core extending at least once through the over molded layer, or with the core adjacent to the over molded layer.

16. The door handle assembly of claim 15, wherein the core comprises at least one spring extending at least partially along a length of the flexible strip.

17. The door handle assembly of claim 15, wherein the at least one spring biases the flexible strip to bow outwardly.

18. The door handle assembly of any of claims 1 through 17, wherein the surface of the door of the motor vehicle comprises an exterior surface of the door of the motor vehicle.

19. The door handle assembly of any of claims 1 through 17, wherein the surface of the door of the motor vehicle comprises an interior surface of the door of the motor vehicle.

20. The door handle assembly of claim 19, further comprising a stretchable or expandable material covering the housing, the door handle, and the at least one actuator guide.
